(19) United States
(12) Patent Application Publication
(10) Pub. No.: US 2006/0070042 A1
(43) Pub. Date: Mar. 30, 2006

(54) Automatic clocking in shared-memory co-simulation

(76) Inventors: Richard D. Muratori, Stow, MA (US); Michael A. O'Hanlon, Limerick (IE); Makaram Raghunandran, Northboro, MA (US)

Correspondence Address: BUCKLEY, MASCHOFF, TALWALKAR LLC, 5 ELM STREET, NEW CANAAN, CT, 06840, US

(21) Appl. No.: 10/949,261

(22) Filed: Sep. 24, 2004

(51) Int. Cl. G06F 9/44

(52) U.S. Cl. 717/135

(57) ABSTRACT

According to some embodiments, it may be determined if a second simulator is in the process of exchanging information with a first simulator, If the second simulator is in the process of exchanging information, it may be arranged for the second simulator to complete the exchange even when the second simulator stops executing instructions.

### BACKGROUND

A processor may execute a software program to perform a function. For example, a processor might execute a software program to examine an information packet, to modify the information packet, and/or to forward the information packet toward a destination. Applications known a “debugging tools” are widely used by developers who write these and other types of software programs. One purpose of a debugging tool may be to let a software developer look for errors in a software program that is under development. By way of example, a debugging tool might simulate the execution of instructions and effectively “freeze” execution of a program at a given instruction. In this way, a developer can inspect the state of the simulation (e.g., by checking the value of a variable or memory content) to gain insight into the workings of the program under examination.

Some processing systems include multiple processors that execute different software programs. The use of multiple processors may result in significant efficiencies, but conventional debugging tools do not readily allow for simultaneous debugging of software programs that will execute on different processors.

### BRIEF DESCRIPTION OF THE DRAWINGS

FIG. 1 is a block diagram of a network processor.

FIG. 2 illustrates a system including a core processor simulator.

FIG. 3 illustrates a system including a processing unit simulator.

FIG. 4 illustrates a system including both a core processor simulator and a processing unit simulator according to some embodiments.

FIGS. 5 and 6 illustrate methods according to some embodiments.

FIG. 7 illustrates a display according to some embodiments.

FIG. 8 is an example of a debugging system according to one embodiment.

FIG. 9 is a state diagram according to some embodiments.

FIG. 10 is a block diagram of a debugging system according to some embodiments.

### DETAILED DESCRIPTION

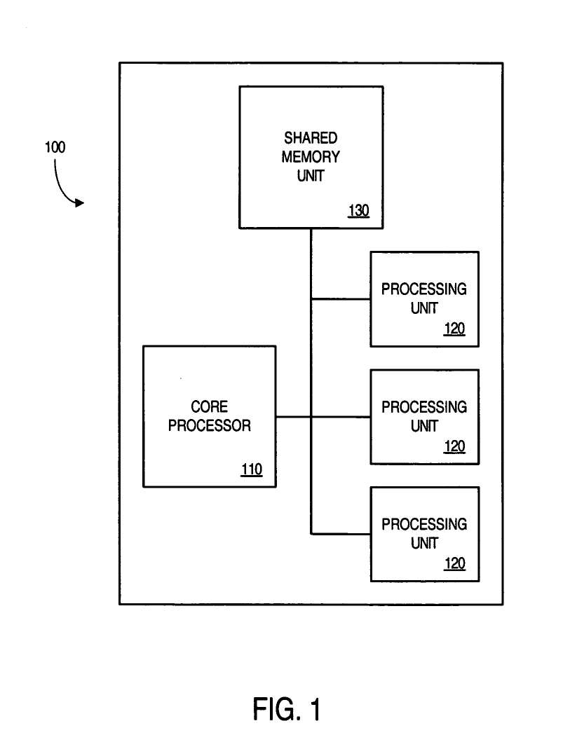

FIG. 1 is a block diagram of a network processor 100. As used herein, the phrase “network processor” may refer to, for example, a device that facilitates an exchange of information via a network, such as a Local Area Network (LAN), or a Wide Area Network (WAN). By way of example, the network processor 100 might facilitate an exchange of information packets in accordance with the Fast Ethernet LAN transmission standard 802.3-2002® published by the Institute of Electrical and Electronics Engineers (IEEE). According to some embodiments, the network processor 100 is associated with a switch, a router (e.g., an edge router), a layer 3 forwarder, and/or protocol conversion. The network processor 100 may, for example, facilitate an exchange of information via one or more networks by receiving, processing, and/or transmitting packets of information (e.g., via a media or switch fabric interface not illustrated in FIG. 1). Examples of network processors include those in the INTEL® IXP 2000 family of network processors.

The network processor 100 may include a core processor 110 (e.g., to process the packets in the control plane). The core processor 110 may comprise, for example, a Central Processing Unit (CPU) able to perform intensive processing on an information packet. By way of example, the core processor 110 may comprise an INTEL® StrongARM core CPU.

The network processor 100 may also include a number of high-speed processing units 120 (e.g., microengines) to process the packets in the data plane. Although three processing units 120 are illustrated in FIG. 1, note that any number of processing units 120 may be provided. Also note that different processing units 120 may be programmed to perform different tasks. By way of example, one processing unit 120 might receive input information packets from a network interface. Another processing unit 120 might process the information packets, while still another one forwards output information packets to a network interface. The processing units 120 might comprise, for example, multi-threaded, Reduced Instruction Set Computer (RISC) microengines adapted to perform information packet processing.

The core processor 110 might exchange information with a processing unit 120 using a shared memory unit 130, such as a Random Access Memory (RAM) unit. For example, the core processor 110 might store information into the shared memory unit 130 to be subsequently retrieved by a processing unit 120. In some cases, hundreds of simulation clock cycles may be required for a processing unit 120 to read information from (or write information to) the shared memory unit 130.

A software program for the core processor 110 and/or a processing unit 120 may be written in, for example, assembly language (e.g., microcode) or a higher-level programming language, such as the C programming language defined by the American National Standards Institute (ANSI)/International Standards Organization (ISO)/International Engineering Consortium (IEC) standard entitled “Programming Languages—C,” Document Number 9899 (Dec. 1, 1999) or the INTEL® Network Classification Language (NCL). Software programs written in such higher-level languages may then be compiled into assembly language and executed.

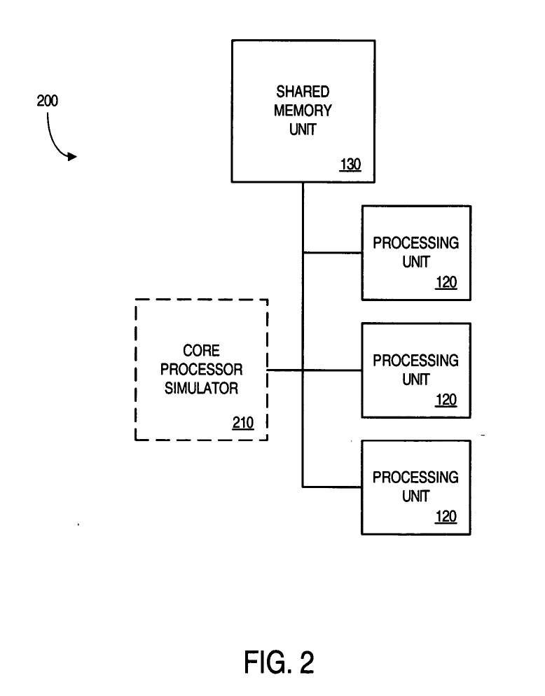

The facilitate development of software programs, code may be executed by a device that simulates the operation of the core processor 110. For example, FIG. 2 illustrates a system 200 including a core processor simulator 210. The core processor simulator 210 might, for example, be a functional simulator (e.g., not every gate of an actual core processor 110 might be simulated). The core processor simulator 210 may include a Graphical User Interface (GUI) debugging interface to a let a developer examine the state of the simulated core processor as a series of instructions are executed.

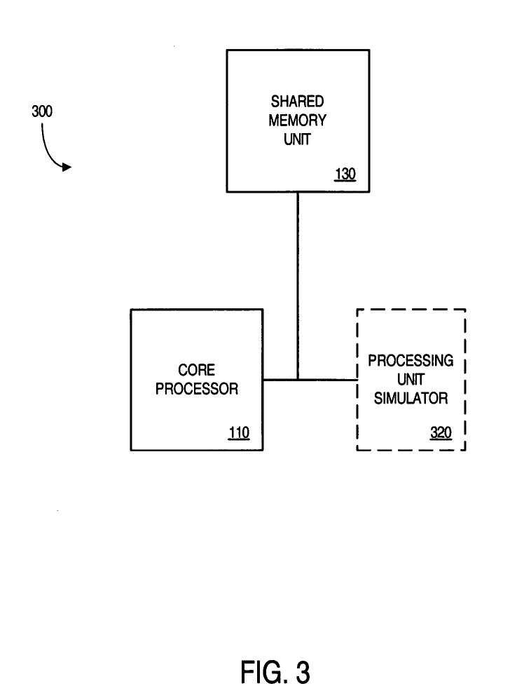

Similarly, FIG. 3 illustrates a system 300 including a processing unit simulator 320. The processing unit simulator 320 might, for example, be a cycle-accurate simulator (e.g., every gate of the an actual processing unit 120 might be simulated). The processing unit simulator 320 might also include a GUI debugging interface (e.g., a developer workbench).

In some cases, however, it may be desirable to cooperatively debug software programs for both the core processor 110 and a processing unit 120 at substantially the same time. This might be the case, for example, when interactions between the core processor 110 and a processing unit 120 are being examined.

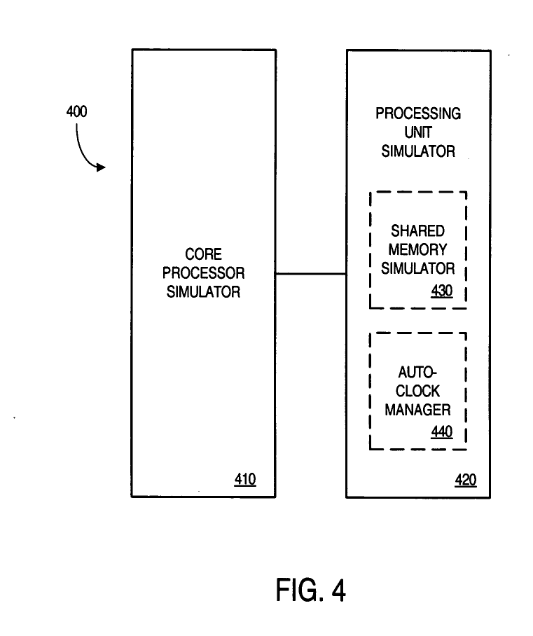

FIG. 4 illustrates a system 400 including both a core processor simulator 410 and a processing unit simulator 420 according to some embodiments. In this example, the processing unit simulator 420 includes a shared memory simulator 430 to facilitate the exchange of information with the core processor simulator 410. Although the shared memory simulator 430 is included in the processing unit simulator 420 in FIG. 4, note that it might instead be provided in the core processor simulator 410 or any other device. According to some embodiments, an actual shared memory unit is used instead of a simulation.

When a software program executing on the core processor simulator 410 attempts to send information to a processing unit via shared memory, the system 400 may arrange for the information to re-directed to a memory model associated with the shared memory simulator 430. Likewise, the processing unit simulator 420 may arrange to read the information from the shared memory simulator 430 instead of an actual shared memory unit (e.g., by simulating a core memory bus).

Note that in some situations, the processing unit simulator 420 might stop executing instructions. For example, a programming error might cause the processing unit simulator 420 to “hang up,” or a break point might be encountered. In such cases, the core processor simulator 410 might be unable to access the shared memory unit simulator 430 (e.g., because the processing unit simulator 420 is stopped). As a result, the core processor simulator 410 may eventually hang-up or otherwise generate an error.

For example, core processor simulator 410 might be sending a block of data to the shared memory simulator 430 (e.g., to a mailbox in the shared memory simulator 430). The processing unit simulator 420 might then encounter break point when half of the block of data has been written. Because it is no longer executing instructions, the processing unit simulator 420 might stop receiving information into the shared memory simulator 430. Moreover, the core processor simulator 410 might be waiting for an indication from the processing unit simulator 420 that the block of data has been received. Since no such indication will be provided in this situation, the core processor simulator 410 might stop (e.g., because it has detected that an error has occurred). Such a situation may limit a software developer's ability to simultaneously debug programs for both a core processor and a processing unit.

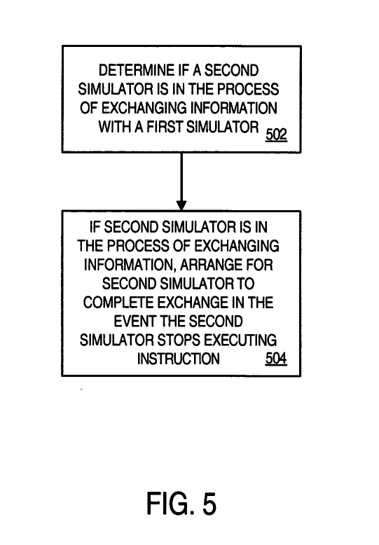

To address this situation, the processing unit simulator may further include an auto-clock manager 440 that operates in accordance with the method illustrated in FIG. 5. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine results in performance according to any of the embodiments described herein.

At 502, it is determined if a second simulator is in the process of exchanging information with a first simulator. For example, it might be determined that the processing unit simulator 420 is in the middle of receiving information from, or sending information to, the core processor simulator 410 (e.g., via the shared memory simulator 430).

At 504, if the second simulator is in the process of exchanging information, it is arranged for the second simulator to complete the exchange in the event the second simulator stops executing instructions. For example, if a break point causes the processing unit simulator 420 to stop executing instructions, the auto-clock manager 440 might arrange for sufficient simulation cycles to be performed to complete an exchange of information via the shared memory simulator 430. In this way, the core processor simulator 410 may receive an indication that the transfer has been completed and avoid hanging up (e.g., as might happen if the core processor simulator 310 instead detected that the transfer never completed).

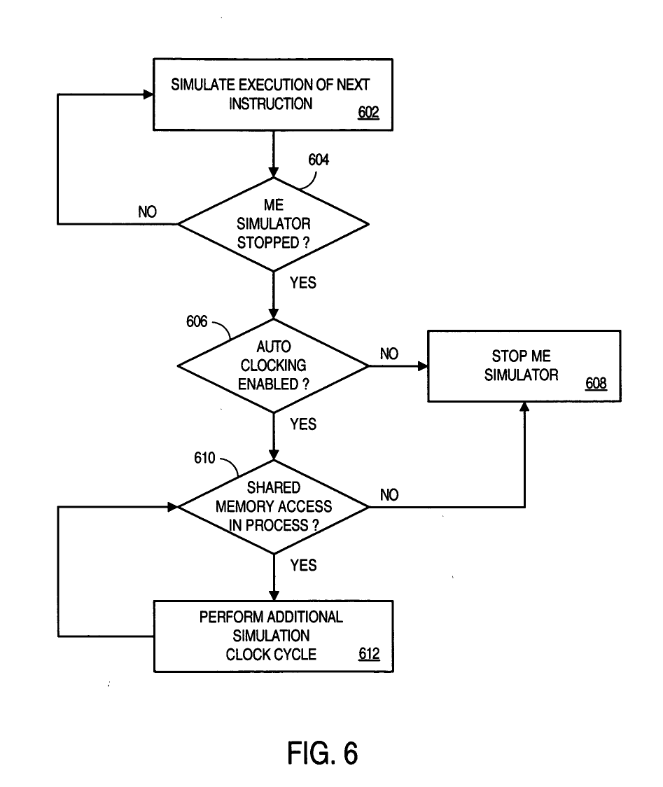

FIG. 6 illustrates a method according to some embodiments. In this case, execution of the next instruction of a microengine program is simulated at 602. If the microengine simulator has not stopped executing instructions at 604 (e.g., it is executing normally), the process continues executing instructions at 602.

When it is detected that the microengine simulator has stopped at 604, it is determined whether or not a user (e.g., a software developer or debugger) has enabled an auto-clocking feature at 606. If the user has not enabled the auto-clocking feature, the microengine simulator simply stops at 608. Note that in this case, there might be an unfinished exchange of information with a core processor simulator (which may eventually cause the core processor simulator to stop).

If the user has enabled the auto-clocking feature at 606, it is determined if there is a shared memory access currently in process at 608. If no shared memory access is currently in process at 608, the microengine simulator simply stops at 608. If a shared memory access is in process, another simulation cycle is performed (e.g., another memory access is permitted) at 612. Simulation cycles are repeated until the transfer is complete (at which point the process stops at 608). As a result, a developer might perform debugging operations on a microengine software program (e.g., inserting a break point) without inadvertently causing another simulator to fail.

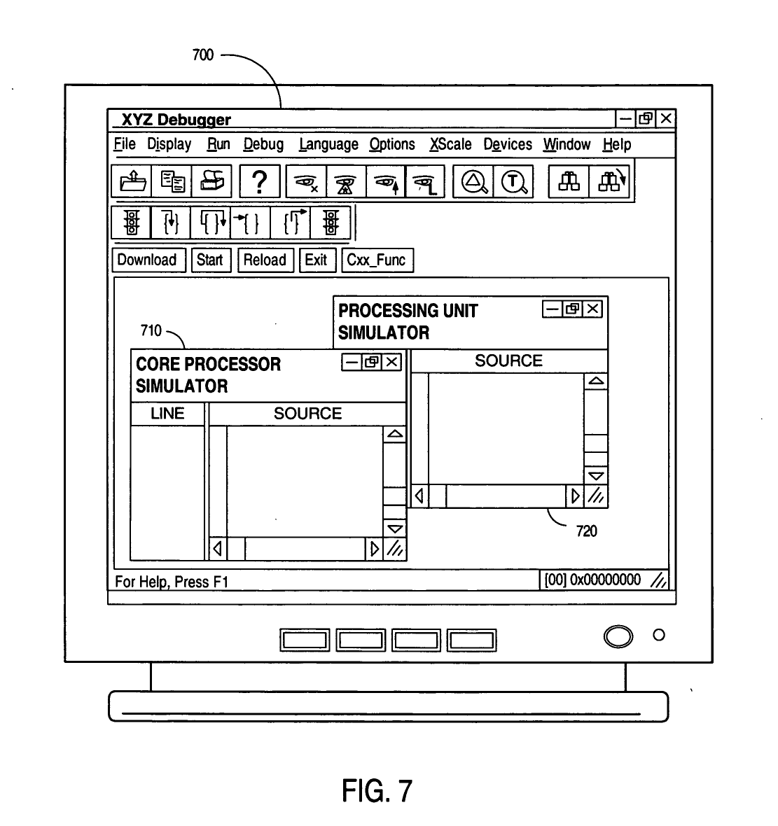

A user might enable (or not enable) the auto-clocking feature using, for example, a GUI display. According to some embodiments, the user can enter a command or select an icon to enable such a feature. According to other embodiments, the feature might be enabled based on which simulator a user is currently working with (e.g., by setting break points or examining data). For example, FIG. 7 illustrates a GUI display 700 including a core processor simulator area 710 and a processing unit simulator area 720. In this case, the auto-clock feature might be enabled when the processing unit simulator area 720 is active (e.g., when it's window is “on top” of the window associated with the core processor simulator area 710).

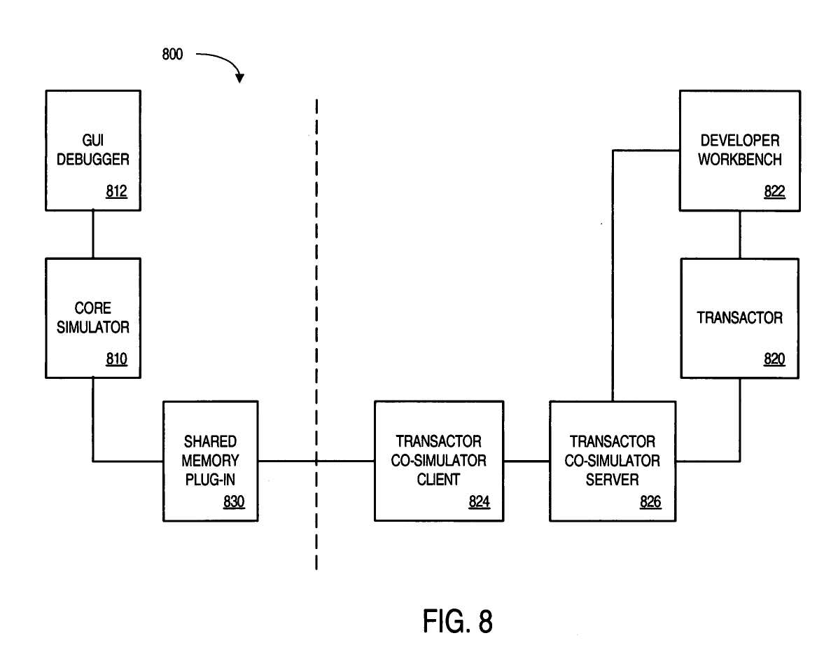

FIG. 8 is an example of a debugging system 800 according to one embodiment. A portion of the system 800 associated with a core processor may include a core simulator 810 that is controlled using a GUI debugger 812. In addition, the core simulator 810 may exchange information via a shared memory plug-in application 830 (e.g., an application adapted to re-direct a shared memory access executed by the core simulator 810).

A portion of the system 800 associated with a processing unit may include a transactor co-simulator client 824 and a transactor co-simulator server 826 that simulate a shared memory unit (e.g., by providing a cycle-accurate simulation of a core memory bus). That is, the transactor co-simulator client 824 may read data from, and write data to, the shared memory plug-in application 830. According to some embodiments, such interactions are performed via a socket-based Inter-Process Communication (IPC). A transactor 820 may simulate the execution of instructions by a processing unit and may be controlled using a developer workbench 822 (e.g., including a GUI display).

According to some embodiments, the developer workbench 822 includes an auto-clocking manager that determines whether: (i) the transactor 820 is running or stopped (e.g., via a status callback from the transactor 820), (ii) auto-clocking is enabled, and (iii) a shared memory access is in process. In this way, the auto-clock manager may control whether or not extra clock cycles should be performed (e.g., to complete a shared memory access). According to some embodiments, the workbench 822 keeps a history when the auto-clocking feature has been activated (e.g., by storing a thread history including specific tags associated with auto-clocking).

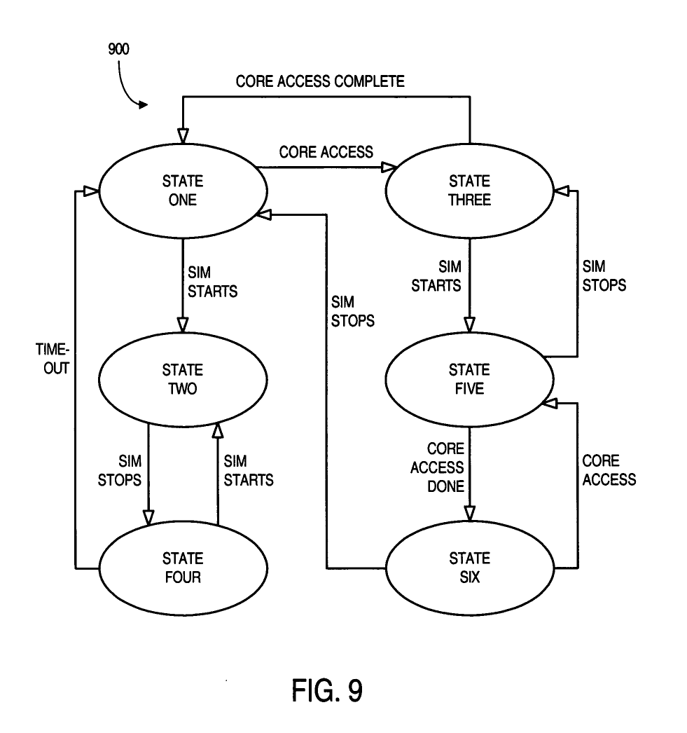

The operation of the auto-clocking manager according to one embodiment is illustrated by the state diagram 900 in FIG. 9. Note that the states illustrated in FIG. 9 assume that the auto-clocking feature has been enabled by the user (or that such a feature is always enabled).

When the developer workbench 822 starts, it calls the transactor co-simulator server 826 and registers a callback in the event that shared memory is being accessed. This corresponds to state one, when the transactor 820 is stopped and auto-clocking is not required. At this point, a user might start executing the transactor 820 simulator, in which case the auto-clocking manager will transfer to state two. If the auto-clocking manager is in state one and receives a callback from the transactor co-simulator server 826 indicating that shared (core) memory is being accessed, it transfers to state three.

In state two, the transactor 820 is running and auto-clocking is not required. According to this embodiment, a “time-out” period is provided to de-bounce the transition between states two and one (e.g., to avoid transitioning when a user is activating a “step” execution icon). That is, if the simulator stops for only a brief period of time, the auto-clocking manager will not return to state one. Thus, when the simulation stops (e.g., due to a user action or asynchronous event), the auto-clocking manager transfers to state four and a timer begins to run. If the timer times-out, the auto-clocking manager transitions to state one. If the simulations starts before the timer times-out, the auto-clocking manager returns to state two.

In state three, the transactor 820 simulator is stopped and there is an outstanding access to shared (core) memory, and thus auto-clocking is required. When the core access is complete, the auto-clocking manager will return to state one. If the simulator should happed to start again (e.g., due to auto-clocking a user action), the auto-clocking manager will transition to state five.

In state five, there is a core memory access in process and the simulation is running. From this state, the auto-clocking manager will return to state three if the simulation stops executing instructions. Moreover, state six will be entered if the core access in process completes.

In state six, the simulation is running and there is no core access in process. If another core access in initiated (e.g., as indicated by a callback from the transactor co-simulator server 826), the auto-clocking manager will return to state five. If the simulation stops when in state six, the auto-clocking manager return to state one.

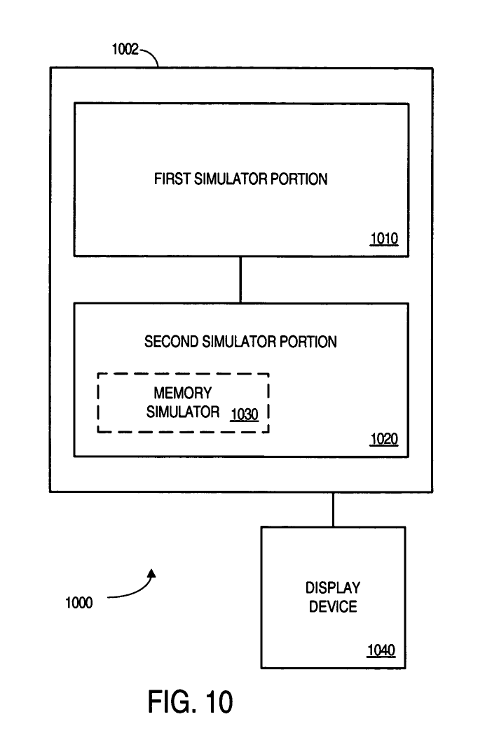

FIG. 10 is a block diagram of a debugging system 1000 according to some embodiments. The system 1000 includes a debugging apparatus 1002 that includes a first simulator portion 1010 and a second simulator portion 1020. Note that the debugging apparatus 1002 might comprise a single device (e.g., a single CPU) or multiple devices (e.g., multiple CPUs or computers). The first simulator portion 1010 might be adapted to functionally simulate, for example, a core processor. The second simulator portion 1020 might be adapted to provide a cycle-accurate simulation of, for example, a microengine. The first simulator portion 1010 and the second simulator portion 1020 may operate in accordance with any of the embodiments described herein. For example, the second simulator portion 1020 might include a memory simulator 1030 that is used to exchange information with the first simulator portion 1010. According to some embodiments, a display device 1040 may be provided (e.g., to provide GUI interface).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some examples have been described with respect to a network processor, embodiments may be used in connection with any type of processing system. Moreover, although software or hardware have been described as performing various functions, such functions might be performed by either software or hardware (or a combination of software and hardware).

The several embodiments described herein are solely for the purpose of illustration. Persons skilled in the art will recognize from this description other embodiments may be practiced with modifications and alterations limited only by the claims.

What is claimed is:

1. A method, comprising:
determining if a second simulator is in the process of exchanging information with a first simulator; and
if the second simulator is in the process of exchanging information, arranging for the second simulator to complete the exchange in the event the second simulator stops executing instructions.

2. The method of claim 1, wherein the first simulator is associated with a core processor and the second simulator is associated with a plurality of processing units.

3. The method of claim 1, wherein the exchange of information is associated with a simulated shared memory unit.

4. The method of claim 3, wherein the second simulator simulates the shared memory unit.

5. The method of claim 1, wherein said arranging includes automatically arranging for the second simulator to execute memory accesses for a number of clock cycles associated with the exchange.

6. The method of claim 1, further comprising:
determining whether or not it should be arranged for the second simulator to complete the exchange.

7. The method of claim 6, wherein the determination of whether or not the exchange should be completed is based at least in part on a user input.

8. The method of claim 6, wherein the determination of whether or not the exchange should be completed is based at least in part on the second simulator not executing instructions for: (i) a period of time, or (ii) a number of clock cycles.

9. The method of claim 1, wherein the first and second simulations execute simultaneously.

10. The method of claim 1, wherein the code is associated with a network processor.

11. The method of claim 10, wherein the network processor is associated with at least one of: (i) Internet protocol information packets, (ii) Ethernet information packets, (iii) a local area network, (iv) a wide area network, (v) a switch, or (vi) a router.

12. The method of claim 11, wherein the first simulator is associated with a StrongARM core processor and the second simulator is associated with a reduced instruction set computer microengine adapted to perform information packet processing in a data plane.

13. A method, comprising:
determining at a first simulator that information is to be exchanged with a second simulator, wherein the first and second simulators execute simultaneously; and
arranging for the exchange of information via a simulated shared memory unit.

14. The method of claim 13, wherein said arranging comprises re-directing a memory access.

15. The method of claim 14, wherein the exchange of information is to be completed even when the second simulator stops executing instructions.

16. A medium storing instructions adapted to be executed by a processor associated with a second simulator to perform a method, said method comprising:
determining if the second simulator is in the process of exchanging information with a first simulator, and
if the second simulator is in the process of exchanging information and the second simulator has stopped executing instructions, automatically arranging for the second simulator to execute memory accesses for a number of clock cycles associated with the exchange.

17. The medium of claim 16, wherein the first simulator is associated with a core processor and the second simulator is associated with a plurality of processing units.

18. The method of claim 16, wherein the exchange of information is associated with a shared memory unit simulated by the second simulator.

19. An apparatus, comprising:
a processing unit simulator;
a core memory bus simulator; and
an auto-clock manager to arrange for the processing unit simulator to complete an exchange of information with another simulator even when the processing unit simulator stops executing instructions.

20. The apparatus of claim 19, further comprising:
a debugger workbench interface to provide an indication from a user as to whether or not it should be arranged for the exchange to be completed.

21. The apparatus of claim 19, wherein the core memory bus simulator is associated with socket-based inter-process communication.

22. A system, comprising:
a first simulator;
a second simulator to execute simultaneously with the first simulator, the second simulator including:
a processing unit simulator, and
an auto-clock manager to arrange for the processing unit simulator to complete an exchange of information with the first simulator in the event the second simulator stops executing instructions; and
a display device to display information associated with at least one of the first simulator or the second simulator.

23. The system of claim 22, wherein the second simulator further includes:
a shared memory unit simulator associated with the exchange of information.

24. The system of claim 22, wherein the second simulator is to store an indication associated with the completion of the exchange.
